(19) United States
(12) Patent Application Publication
(10) Pub. No.: US 2023/0130825 A1
(43) Pub. Date: Apr. 27, 2023

(54) SECURE LOGISTICAL RESOURCE PLANNING

(71) Applicant: Accenture Global Solutions Limited, Dublin (IE)

(72) Inventors: Ghanshyam Devnani, Bengaluru (IN); Loganantha Naidu Esparan, Petaling Jaya (MY); Kumud Ranjan Jha, Bedok (SG); Wei Qi Tan, Kuala Lumpur (MY); Vivek Luthra, Melbourne (AU)

(21) Appl. No.: 17/975,032

(22) Filed: Oct. 27, 2022

Related U.S. Application Data
(60) Provisional application No. 63/272,320, filed on Oct. 27, 2021.

(51) Int. Cl. G06Q 30/02; G06Q 10/02; G06Q 10/04

(52) U.S. Cl. CPC G06Q 30/0206; G06Q 10/02; G06Q 10/047

(57) ABSTRACT

Implementations include receiving, from a first system, resource request data indicating a first type of logistical resource to be reserved by a first enterprise of a plurality of enterprises; processing the resource request data using a forecast model to produce output including a forecasted demand for the first type of logistical resource; receiving, from a second system, resource availability data indicating availability of the first type of logistical resource; and based on the forecasted demand and on the resource availability data, providing, to the first system, suggested reservation data indicating available resources for accommodating the forecasted demand. Implementations include determining, based on the forecasted demand and on the resource availability data, a predicted cost of the available resources, and presenting, by the first system and through a graphical user interface, the suggested reservation data.

### CROSS-REFERENCE TO RELATED APPLICATIONS

This application claims priority to U.S. 63/272,320, filed on Oct. 27, 2021, the disclosure of which is expressly incorporated herein by reference in the entirety.

### FIELD

This specification relates to systems for securely improving efficiency in transporting people and/or materials.

### BACKGROUND

Transportation logistics involve a highly complex nature of operations and numerous operational constraints. Logistical planning is impacted by dynamically changing needs of enterprises that are supported by resource providers. The traditional logistics operating model for processes-industries such as oil and gas, mining, construction, and utilities is challenged by poor asset utilization resulting in resource wastage and high carbon footprint across the value chain. This complexity results in inefficient operation of transportation vehicles, which results in undesirable expenditure of resources, such as energy (e.g., fuel, electricity). It is desirable to efficiently manage fuel consumption of transportation vehicles while also ensuring that shipping schedules meet user requirements of cost and service levels and balanced capacity requirements.

### SUMMARY

Implementations of the present disclosure are directed to improving efficiency in transporting material and/or personnel. More particularly, implementations of the present disclosure are directed to a logistical planning platform that trains a demand forecast model to predict demand for logistical resources. The disclosed techniques can be used to augment and make tactical decisions based on dynamic resource demand and availability for improved efficiency in transportation and reduced resource consumption (e.g., fuel, electricity).

The present disclosure provides a system and method to accurately predict demand for logistical resources. Logistical resources can include, for example, available space for material or personnel on a transport vehicle or vessel. The transport vehicle can be, for example, a marine vessel, an aircraft, a truck, a train, or another type of vehicle that can be used to move material, personnel, or both, from one place to another.

The disclosed methods can be used to train a model to predict demand for a particular resource by multiple different enterprises. The trained demand forecast model can receive, as input, data indicating a type of logistical resource to be reserved by an enterprise, and can output suggested reservation data for use in reserving available resources to accommodate the demand.

A demand forecast model can be trained using historical data indicating logistical resources used by multiple enterprises. Resources can include, for example, space on a vessel that can be used to transport material and/or personnel to a destination. A demand forecast model can receive input data that includes a type of resource to be reserved by an enterprise, and generate corresponding output data. The output data can include suggested reservation data including a time of availability of the type of resource and an amount of the resource that is forecasted to be available. The output data can be compared to ground truth data indicating actual resources used by the enterprises. Parameters of the demand forecast model can be adjusted based on comparing the output data to the ground truth data. The demand forecast model can be, for example, a machine learning model (e.g., a convolutional neural network model, an autoencoder model). In some examples, the demand forecast model can be integrated into a logistical resource reservation system or booking system.

Implementations provide a demand aggregation platform that captures demand securely and provides visibility across the logistical ecosystem. Early demand provisioning is incentivized through demand-based cost estimates and recommended reservations. Machine learning is used to predict and forecast expected demand.

The disclosed implementations can be used improve schedule reliability, transportation vessel idling time, fleet shipping capacity, and fuel consumption. Thus, implementations may reduce environmental impacts of transport vessels, such as reduced resource consumption, while improving operational efficiency and reducing costs of operating the transport vehicles.

The disclosed techniques can provide enterprises with secure logistical resource booking. To address cross-entity data privacy challenges while allowing for sharing of critical data for analytics, the platform can use homomorphic encryption technology. This ensures privacy remains intact, as only critical non-sensitive data is shared to machine learning algorithms.

The disclosed techniques can provide enterprises with incentive-driven demand and can enable early demand capture. Resource demand forecasts can be provided directly into user interfaces of an application used for reserving resources. The user interfaces can provide up-to-date information indicating availability and cost of resources.

The disclosed techniques provide intelligent demand forecasting using machine learning algorithms. The demand forecast model can be continuously improved using closed loop machine learning and analytics. In some examples, real-time tracking of demand can be presented to users through user interfaces through integration with a geo-tracking platform.

The disclosed techniques provide cross-industry supply chain management that enables demand consolidation across enterprises and organizations, and allows dynamic spot reservation and pricing. Logistical resource usage data is provided, through a feedback loop, to improve demand forecasting while allowing data privacy to remain intact.

In some implementations, actions include receiving, from a first system, resource request data indicating a first type of logistical resource to be reserved by a first enterprise of a plurality of enterprises; processing the resource request data using a forecast model to produce output including a forecasted demand for the first type of logistical resource; receiving, from a second system, resource availability data indicating availability of the first type of logistical resource; and based on the forecasted demand and on the resource availability data, providing, to the first system, suggested reservation data indicating available resources for accommodating the forecasted demand.

Other implementations of this aspect include corresponding systems, apparatus, and computer programs, configured to perform the actions of the methods, encoded on computer storage devices.

These and other implementations can each optionally include one or more of the following features: the forecasted demand includes a forecasted demand of the first enterprise; the forecasted demand includes a forecasted demand of each of the plurality of enterprises; the actions includes presenting, by the first system and through a graphical user interface, the suggested reservation data; the suggested reservation data includes multiple selectable scheduling options for the available resources, the actions including: receiving, from the first system, data indicating a user selection of one or more of the selectable scheduling options; and in response to receiving the data indicating the user selection, providing, to the second system, a request to reserve the available resources associated with the selected one or more scheduling options; the actions include determining, based on the forecasted demand and on the resource availability data, a predicted cost of the available resources; the suggested reservation data includes data indicating the predicted cost of the available resources; the forecast model includes a convolutional neural network model; the first type of logistical resource includes at least one of a resource for transporting material or a resource for transporting personnel.

In some implementations, actions include storing, in a database, enterprise data indicating logistical resources used by a plurality of enterprises, including first enterprise data for a first enterprise; training, using the enterprise data, the demand forecast model to forecast demand for logistical resources while providing security for the first enterprise data from access by the plurality of enterprises and any third party; receiving first reservation data indicating logistical resources reserved by the first enterprise; and updating the demand forecast model based on the first reservation data, while providing security for the first reservation data from access by the plurality of enterprises and any third party.

Other implementations of this aspect include corresponding systems, apparatus, and computer programs, configured to perform the actions of the methods, encoded on computer storage devices.

These and other implementations can each optionally include one or more of the following features: the actions include training, using the enterprise data, the demand forecast model to forecast demand for logistical resources for each of the plurality of enterprises; the actions include receiving reservation data indicating logistical resources reserved by one or more of the plurality of enterprises; and updating the demand forecast model based on the reservation data; the actions include receiving, from the plurality of enterprises, unencrypted enterprise data; encrypting the enterprise data using homomorphic encryption; and storing the encrypted enterprise data in the database; the demand forecast model includes a convolutional neural network model.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

FIG. 1 depicts an example system for secure logistical resource planning in accordance with implementations of the present disclosure.

FIG. 2 depicts an example conceptual architecture of a resource management engine in accordance with implementations of the present disclosure.

FIGS. 3A and 3B depict example user interfaces for receiving resource request data in accordance with implementations of the present disclosure.

FIG. 4 depicts an example user interface displaying logistical resource options for transporting material in accordance with implementations of the present disclosure.

FIG. 5 depicts an example user interface displaying logistical resource options for transporting personnel in accordance with implementations of the present disclosure.

FIG. 6 depicts an example user interface for receiving confirmation of resource demand in accordance with implementations of the present disclosure.

FIG. 7 depicts an example user interface for displaying confirmed reservations for logistical resources in accordance with implementations of the present disclosure.

FIG. 8 depicts an example user interface for displaying an itinerary for a confirmed reservation in accordance with implementations of the present disclosure.

FIG. 9 depicts an example user interface for displaying an invoice for a confirmed reservation in accordance with implementations of the present disclosure.

FIG. 10 is a flowchart of an example process that can be executed in accordance with implementations of the present disclosure.

FIG. 11 is a flowchart of an example process that can be executed in accordance with implementations of the present disclosure.

Like reference numbers and designations in the various drawings indicate like elements.

### DETAILED DESCRIPTION

Implementations of the present disclosure are directed to improving efficiency in transporting material and personnel. More particularly, implementations of the present disclosure are directed to a logistical planning platform that trains a demand forecast model to predict demand for logistical resources. The trained demand forecast model can predict a consolidated demand from across multiple organizations or enterprises. The disclosed techniques can be used to augment and make tactical decisions based on dynamic resource demand and availability for improved efficiency in transportation and reduced resource consumption (e.g., fuel, electricity).

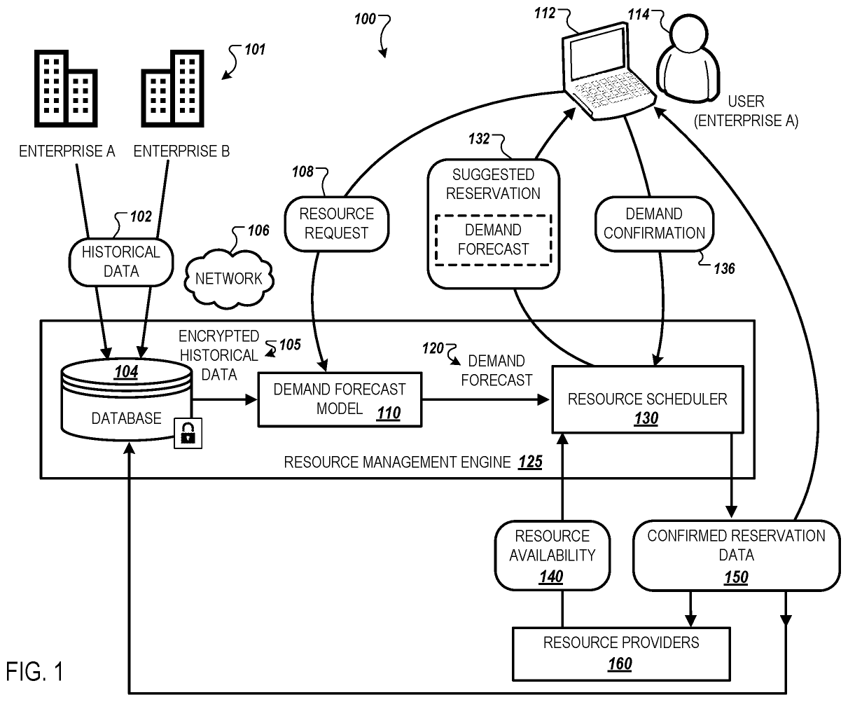

FIG. 1 depicts an example system 100 for secure logistical resource planning in accordance with implementations of the present disclosure. The system 100 includes a resource management engine 125. The resource management engine 125 communicates with enterprises 101, with a computing device 112, and with a resource provider 160 over a network 106. The resource management engine 125 includes a database 104, a demand forecast model 110, and a resource scheduler 130.

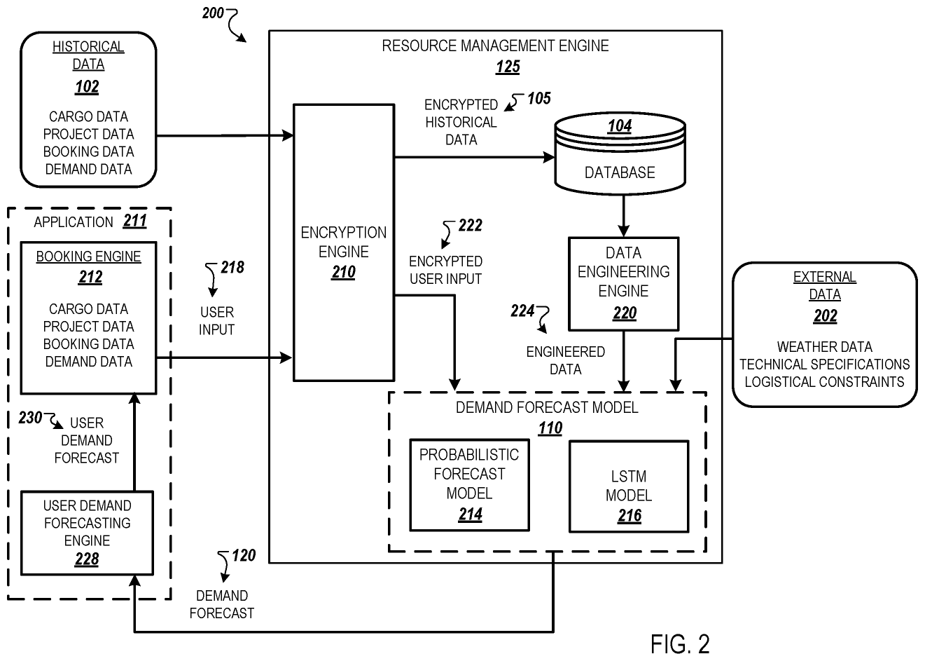

The enterprises 101 include Enterprise A and Enterprise B. Enterprises A and B can be, for example, organizations that use logistical resources. For example, Enterprises A and B can each be an organization that uses space on transport vehicles to move people and/or materials from one place to another. The resource management engine 125 receives historical data 102 from the enterprises 101. The historical data 102 is described in greater detail with reference to FIG. 2.

The resource management engine 125 stores the historical data 102 in the database 104. The database 104 can be a data storage or data warehouse that stores encrypted historical data 102 from multiple enterprises. Encryption of the historical data 102 is described in greater detail with reference to FIG. 2.

The demand forecast model 110 is trained using historical data indicating logistical resources used by multiple enterprises, e.g., encrypted historical data 105 from the database 104. The demand forecast model 110 receives, as input, the encrypted historical data 105. The logistical resources can include, for example, space on a vessel that has been used to transport material and/or personnel to a destination. During a training process, the demand forecast model 110 processes the encrypted historical data 105 to produce output data predicting future resource demand. The output data can be compared to ground truth data indicating actual resources used by the enterprises. Parameters of the demand forecast model can be adjusted based on comparing the output data to the ground truth data.

In an example, the demand forecast model 110 processes encrypted historical data 105 to produce output predicting that Enterprise A will use ten passenger seats on a particular transport route on Tuesday, May 7. On Tuesday, May 7, Enterprise A uses nine passenger seats. The use of nine passenger seats on Tuesday, May 7 can be used as ground truth data representing the actual resource usage. The ground truth data indicating the use of nine passenger seats can be compared to the predicted usage of ten passenger seats. Parameters of the demand forecast model 110 can be adjusted based on the comparison of the predicted usage to the ground truth usage.

In some examples, the demand forecast model 110 is a machine learning model. For example, the demand forecast model 110 can include a convolutional neural network model, e.g., an autoencoder model, a recursive neural network, a recurrent neural network, a long-short-term-memory (LSTM) model, a deep LSTM model, and/or another type of machine learning model. In some examples, the demand forecast model is a machine learning ensemble model, e.g., an Autoregressive integrated moving average model (Arimax). The demand forecast model 110 can utilize historical time series data, including seasonality trends, to predict the demand.

In some examples, the demand forecast model can be integrated into a logistical resource reservation or booking system.

The trained demand forecast model 110 can be used to perform inference on a request for logistical resources received from an enterprise. The demand forecast model 110 can receive, as input, a resource request 108 including data indicating a type of logistical resource to be reserved by an enterprise. For example, as shown in FIG. 1, a user 114, representing Enterprise A, provides user input for the resource request 108 through a computing device 112. The computing device 112 receives the user input and sends the resource request 108 to the resource management engine 125.

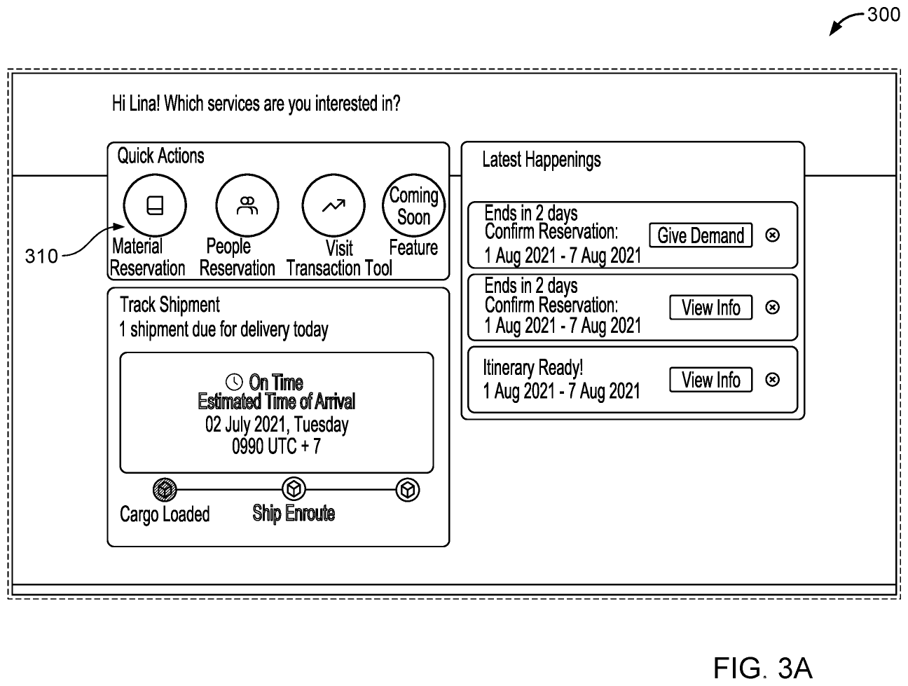

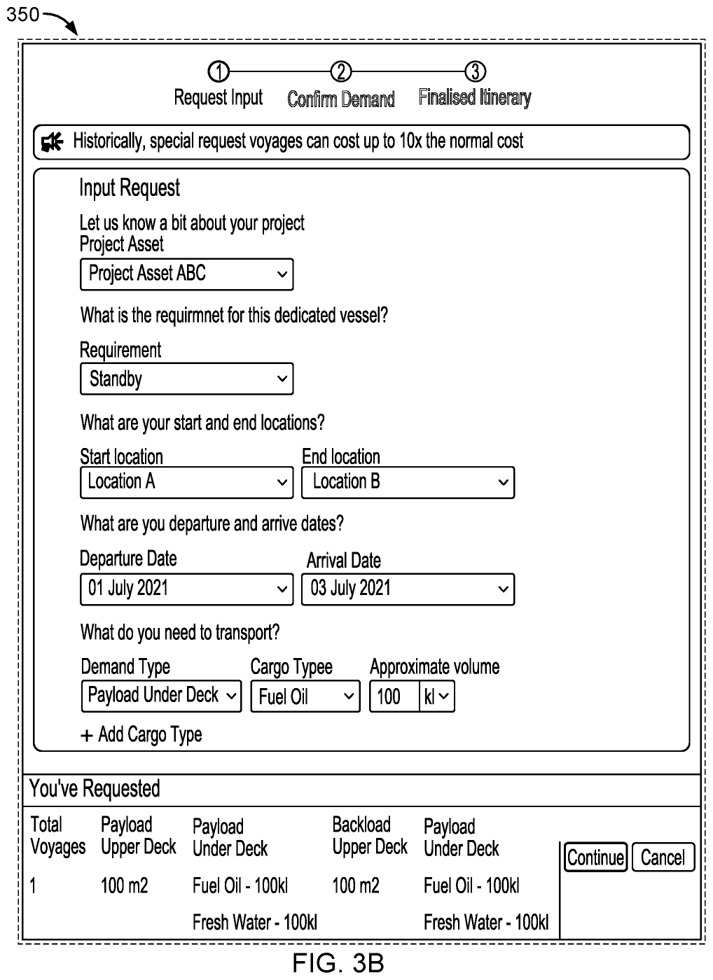

FIGS. 3A and 3B show an example user interfaces 300, 350 through which the user 114 can provide user input for the resource request 108. The user interfaces 300, 350 can be presented to the user 114 on a display of an electronic device, e.g., the computing device 112. The user interface 300 depicts an example user interface for receiving resource request data. The user interface 300 includes selectable icons 310 for multiple different types of logistical resources that be reserved. The types of logistical resources include, for example, material and people.

Referring back to FIG. 1, the demand forecast model 110 outputs a demand forecast 120. The demand forecast 120 includes predicted demand for enterprise A for the type of resource indicated in the resource request 108. For example, the demand forecast 120 can include an amount of material to be transported, a number of people to be transported, a time of transport, an origin location, a destination location, or any combination of these. The predicted amount of material to be transported can include, e.g., a predicted volume of fuel, a predicted volume of fresh water, a predicted volume of dry cargo, or any combination of these.

Although shown in FIG. 1 as receiving the resource request 108 from a single user representing a single enterprise, the demand forecast model 110 can receive multiple resource requests from multiple users, multiple enterprises, or both. In some examples, the demand forecast model 110 can predict resource demand for each of the multiple enterprises 101 and can output a total combined demand forecast 120 for the multiple enterprises 101.

The demand forecast model 110 provides the demand forecast 120 to the resource scheduler 130. The resource scheduler 130 receives resource availability data 140 from one or more resource providers 160. The resource availability data 140 can include, for example, schedules of transport vehicles, available material space on the transport vehicles, available passenger space on the transport vehicles, or any combination of these. The schedule of a transport vehicle can include, for example, a planned origin location, a destination location, a travel route for the vehicle, one or more waypoints along the route, an expected time of arrival, an expected time of departure, or any combination of these.

The resource scheduler 130 aligns the demand forecast 120 with the resource availability data 140. In some examples, the resource scheduler 130 can identify, for each requested resource included in the demand forecast 120, one or more available resources for accommodating the request. For example, the resource scheduler 130 can assign a demand forecast of five passengers the week of January 12 to one or more resources that are available to transport at least five passengers during the week of January 12.

In some examples, the resource scheduler 130 can determine a predicted cost of resources based on the resource availability data 140 and the demand forecast 120. For example, the demand forecast 120 may include a demand across multiple enterprises to transport fifty passengers to a particular destination during the week of January 12, and a demand to transport thirty passengers to the particular destination during the week of January 19. The resource availability data 140 may include a total availability of forty passenger seats during both the week of January 12 and the week of January 19. The resource scheduler 130 can determine that the forecasted demand for the week of January 12 is greater than the forecasted demand for the week of January 19, and is greater than the resource availability during the week of January 12. The resource scheduler 130 can therefore predict a higher cost to transport passengers to the particular destination during the week of January 12, compared to during the week of January 19.

The resource management engine 125 can provide suggested reservation data 132 to the computing device 112. In some examples, the resource scheduler 130 can use collaborative filtering techniques to develop the suggested reservation data 132, including recommendations for users to reserve available resources. In some examples, the suggested reservation data 132 can include the demand forecast 120. In some examples, the suggested reservation data 132 can include a suggested resource assignment for requested resource represented by the demand forecast 120. For example, the suggested reservation data 132 can include the predicted demand for enterprise A assigned to a suggested resource that is available to accommodate the demand, according to the resource availability data 140.

The suggested reservation data 132 can include a time of availability of the type of resource. For example, the suggested reservation data 132 can include data indicating that a personnel transport vessel is available on January 13 to travel to a particular destination. The suggested reservation data 132 can include an amount of the resource that is forecasted to be available at that time. For example, the suggested reservation data 132 can include data indicating a number of personnel seats that are expected to be available on the personnel transport vessel on January 13, e.g., five personnel seats.

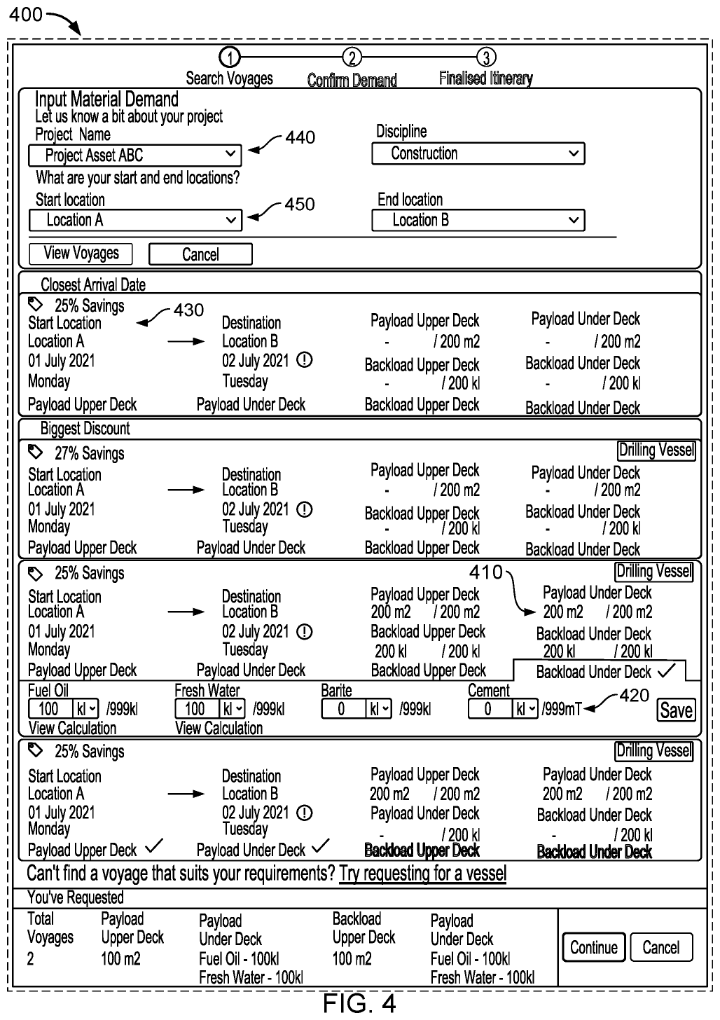

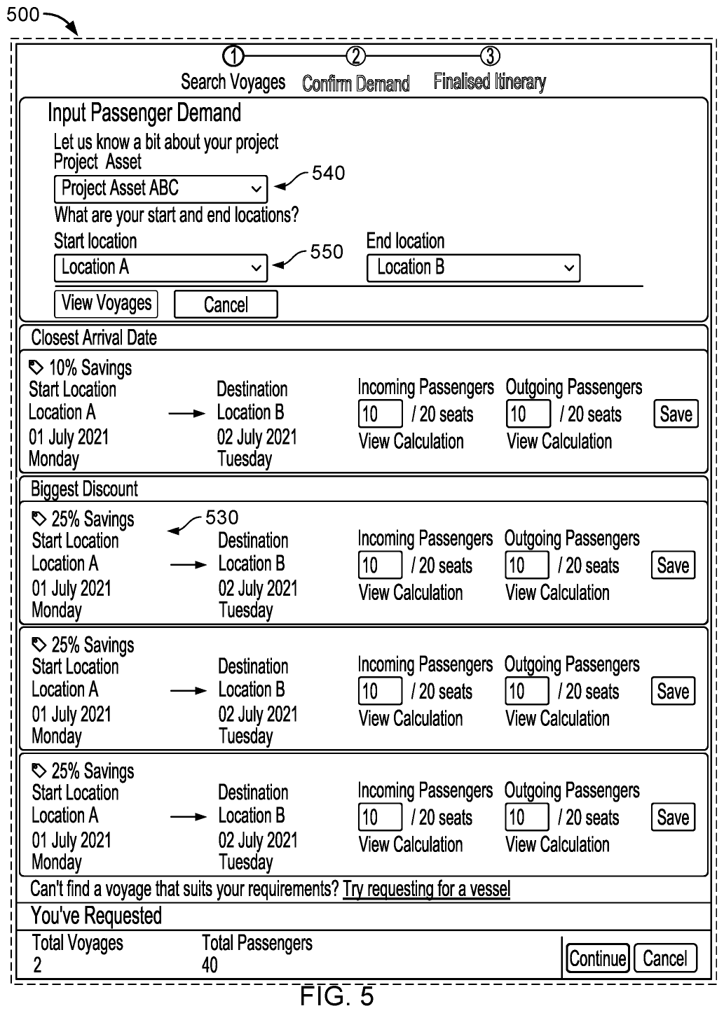

FIGS. 4 and 5 show example user interfaces 400 and 500, respectively, through which the resource management engine 125 can provide the suggested reservation data 132. Specifically, the user interface 400 displays logistical resource options for transporting material, and the user interface 500 displays logistical resource options for transporting personnel.

The user interface 400 displays scheduling options for transporting material from a particular origin to a particular destination. The user interface 400 includes fields for entering a project name and type 440, and for entering a start and end location 450. When displayed on the computing device 112, the fields for the project name and type 440 and for the start and end location 450 can be pre-populated based on the demand forecast 120. Each of the displayed scheduling options can also be pre-populated with predicted amounts of material 410 to be transported based on the demand forecast 120. The user interface 400 provides fields 420 for the user to adjust the pre-populated values and amounts as needed.

Each of the scheduling options presented through the user interface 400 includes a scheduled departure time, arrival time, and predicted cost or relative cost. For example, scheduling option 430 is displayed with an associated predicted savings of 25%. In some examples, the scheduling options can be presented through the user interface 400 in a priority order, according to capacities, availabilities, costs, or any combination of these. For example, scheduling options having the greater capacity, a greater availability, and/or a lower cost can be presented above scheduling options having lesser capacity, a lesser availability, and/or a higher cost.

Similarly, the user interface 500 displays scheduling options for transporting people from a particular origin to a particular destination. The user interface 500 includes fields for entering a project name 540, and for entering a start and end location 550. When displayed on the computing device 112, the fields for the project name 540 and for the start and end location 550 can be pre-populated based on the demand forecast 120. Each of the displayed scheduling options can also be pre-populated with predicted numbers of personnel 510 to be transported based on the demand forecast 120. The pre-populated values and numbers can be adjusted and saved by the user through the user interface 500 as needed.

Each of the scheduling options presented through the user interface 500 includes a scheduled departure time, arrival time, and predicted relative cost. For example, scheduling option 530 is displayed with an associated predicted savings of 25%.

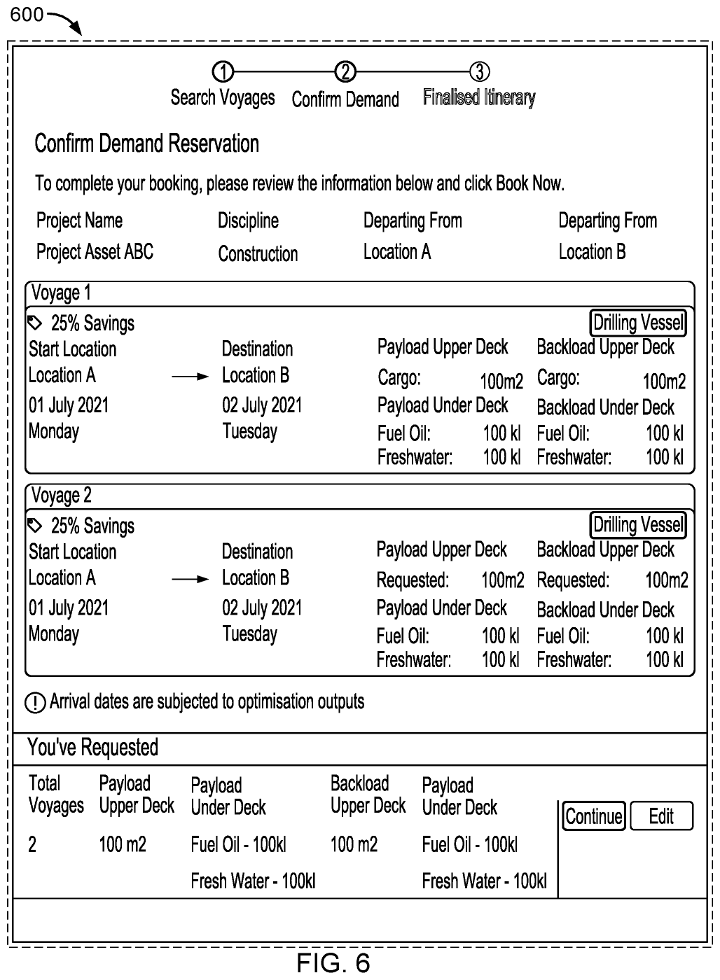

The suggested reservation data 132 is presented to a user, e.g., the user 114, through the user interfaces 400 and/or 500 displayed by the computing device 112. The user 114 can adjust values pre-populated in the user interfaces 400 and/or 500 in order to tailor the reservation to the needs of Enterprise A. The computing device 112 can receive input from the user 114 confirming the demand. FIG. 6 shows an example user interface 600 for receiving user input indicating a demand confirmation 136. The demand confirmation 136 is a confirmation of the type of resource, the amount of the type of resource, and the time at which the resource is needed. In the example of FIG. 6, the demand confirmation 136 indicates a request of two voyages on 1 Jul. 2021 for transporting specified amounts of material from Kemaman to Samarang. The computing device 112 sends the demand confirmation 136 to the resource scheduler 130.

The resource scheduler 130 receives the demand confirmation 136 from the computing device 112 over the network 106. The resource scheduler 130 can then reserve the resource for accommodating the confirmed demand. The resource scheduler 130 outputs confirmed reservation data 150. The confirmed reservation data 150 can include, for example, the scheduling option selected by the user 114 and the amounts and types of resources included in the demand confirmation 136. The resource scheduler 130 can provide the confirmed reservation data 150 to the resource providers 160. In some examples, the confirmed reservation data 150 can request use of a particular transport vehicle at a particular time and location.

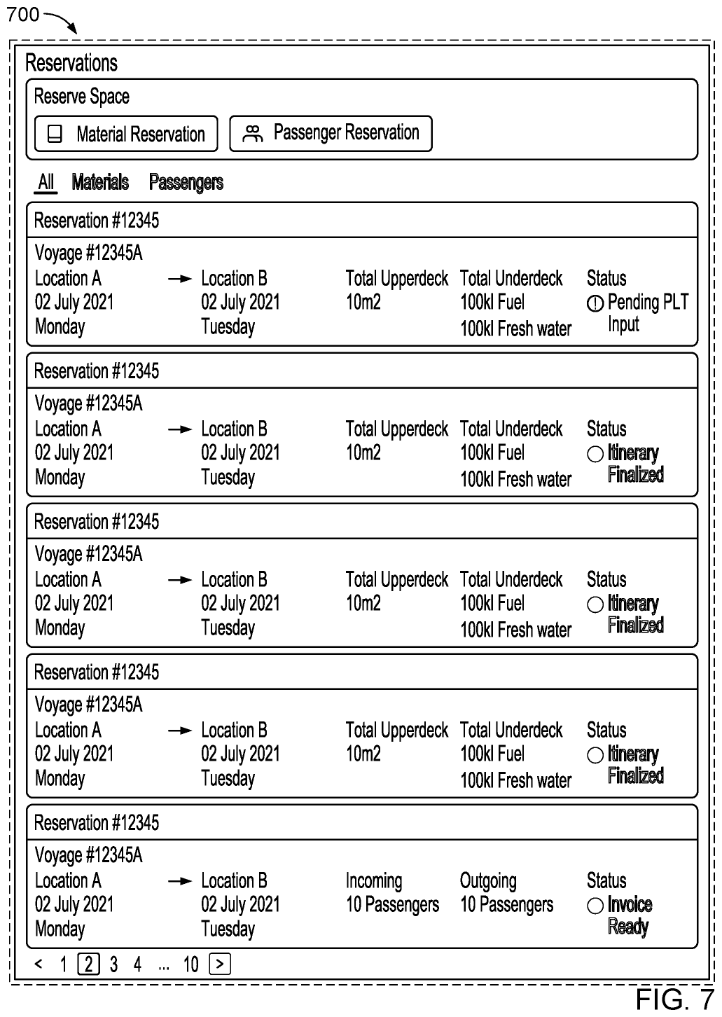

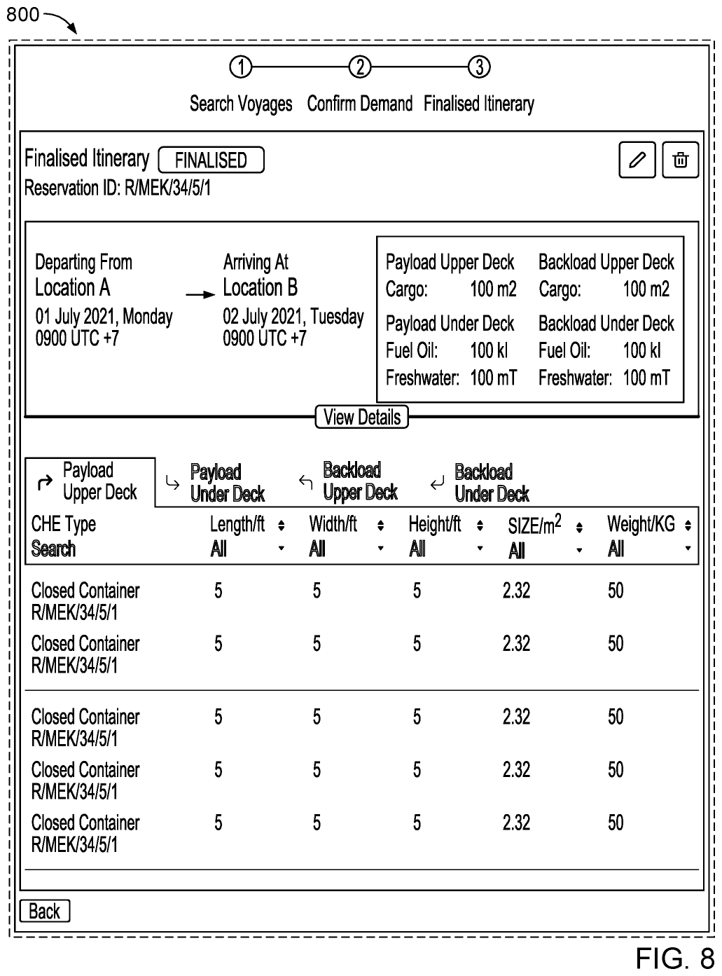

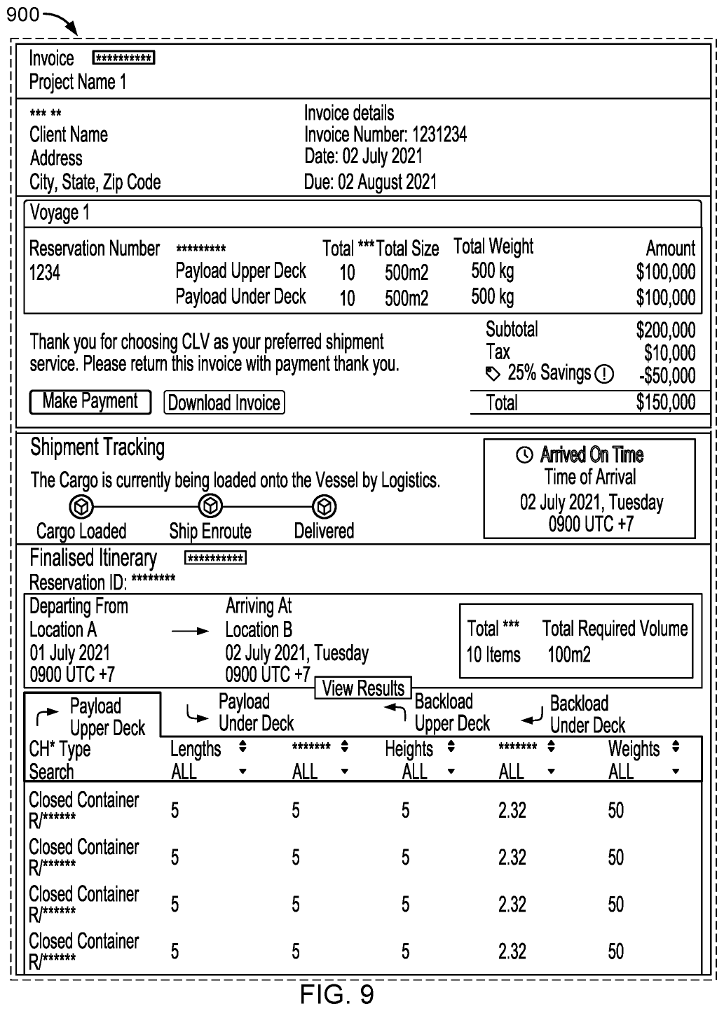

The resource scheduler 130 can provide the confirmed reservation data 150 to the computing device 112 for presentation to the user 114. FIG. 7 depicts an example user interface 700 for displaying confirmed reservations for logistical resources. FIG. 8 depicts an example user interface 800 for displaying an itinerary for a confirmed reservation. FIG. 9 depicts an example user interface 900 for displaying an invoice for a confirmed reservation.

The resource scheduler 130 can provide the confirmed reservation data 150 to the database 104. The confirmed reservation data 150 in the database 104 can then be used to train the demand forecast model 110 in order to improve accuracy of the demand forecast model 110.

FIG. 2 depicts an example conceptual architecture 200 of the resource management engine 125. As described with reference to FIG. 1, the resource management engine 125 receives historical data 102. In some examples, the historical data 102 can include historical demand profiles, e.g., time-varying historical demand for resources. The historical data 102 can include data collected over a time duration, e.g., of several months or years. In some examples, the historical data 102 includes data collected over a time duration of six months or more. In some examples, the historical data 102 includes data collected over a time duration of one year or less.

The historical data 102 can include booking data including a booking identifier, a reservation identifier, a user identifier, and/or a requestor identifier. In some examples, the booking data can be anonymized. The historical data 102 can include project data including a project name, operation, and/or business unit associated with the booking.

The historical data 102 can include demand data indicating an origin, a pickup point, a destination, and drop off location for each leg of the journey. The demand data can include a requested date and time of the demand. The demand data can include data indicating a special booking, e.g., a custom request for special booking that includes a location, date, and a volume of material.

The historical data 102 can include cargo data including cargo manifests for material and personnel transport. The cargo data can include, for example, an upper deck capacity requirement, a lower deck capacity requirement, and a requested number of seats for personnel. The cargo data can include backload, e.g., data indicating cargo to be picked up at a particular location of an incoming journey. The cargo data can include payload, e.g., data indicating cargo to be dropped off at a particular location of an outgoing journey. The cargo data can also include data indicating dangerous goods, including a classification of the material.

The resource management engine 125 includes an encryption engine 210 for encrypting ingested data. The encryption engine 210 can use encryption processes such as homomorphic encryption to consolidate demand of all companies, without putting data privacy at risk. The encryption processes can be used in conjunction with the existing enterprise systems, exposing only non-private data for analytics and encrypting all other data.

Homomorphic encryption is a form of encryption that permits users to perform computations on its encrypted data without first decrypting it. The resulting computations are left in an encrypted form which, when decrypted, result in an identical output to that produced had the operations been performed on the unencrypted data. Homomorphic encryption can be used for privacy-preserving outsourced storage and computation. This allows data to be encrypted and out-sourced to commercial cloud environments for processing, all while encrypted.

For sensitive data, homomorphic encryption can be used to enable services by removing privacy barriers inhibiting data sharing and can increase security to existing services. For example, predictive analytics can operate on encrypted data instead of unencrypted data, in order to reduce privacy concerns. Even if the security of the resource management engine 125 is compromised, the data remains secure.

The encrypted historical data 105 is stored in the database 104. A data engineering engine 220 processes encrypted historical data 105 from the database 104. In some examples, the data engineering engine 220 can pre-process, sort, filter, categorize, label, and classify data from the database 104. The data engineering engine 220 outputs engineered data 224 (e.g., encrypted historical data 105 after being processed by the data engineering engine 220) to the demand forecast model 110. The engineered data 224 is used to train the demand forecast model 110.

The resource management engine 125 receives external data 202. The external data can include weather data. In some examples, the weather data includes historical weather data representing historical weather conditions at the location of the project. In some examples, the weather data includes weather forecast data representing predicted weather conditions at the location of the project

The external data 202 can include logistical constraints, e.g., operating times and hours of facilities, scheduling constraints, or any combination of these. The external data 202 can include technical specifications, e.g., requirements of transport vehicles and facilities, required environmental conditions for transporting cargo and personnel, or any combination of these.

The demand forecast model 110 receives, as input, the engineered data 224 and the external data 202. The demand forecast model 110 includes at least one probabilistic forecast model 214 and at least one LSTM model 216. The probabilistic forecast model 214 can predict future demand through probabilistic demand profile and Bayesian forecasting. The probabilistic forecast model 214 can create a demand profile using elements of the engineered data 224. For example, the probabilistic forecast model 214 can create a demand profile using project names, business units, types of bookings, demand types, and cargo types included in the engineered data 224.

The probabilistic forecast model 214 can perform profiling and/or segmentation using, for example, a two-step fuzzy c-means clustering approach. The first level of clusters can be based upon the project name, business units, and/or the booking type. The second level of clustering can be based upon the demand type and cargo type. Each request can be categorized in multiple segments with their likelihood of being classified in each cluster. Thus, a project requirement can be defined using clusters with given probability scores. This provides flexibility for the probabilistic demand prediction.

Once the demand profiles are prepared, a Bayesian-based forecasting method can be used to predict future demand. The Bayesian model can perform forecasting based on a small amount of data. In some examples, the Bayesian model can be trained using daily data collected over a historical time duration. For example, the daily data can be collected over a duration of six months or greater and/or over a duration of one year or less. Additionally, the Bayesian model can provide the flexibility of predicting a confidence interval as well as a point estimate for the demand. For example, the Bayesian model can provide a 95% confidence interval (e.g., a credible interval) for which there is a 95% probability that the true (unknown) estimate would lie within the interval, given the evidence provided by the observed data. An advantage of using a probabilistic forecasting method is flexibility of choosing the demand profile based on the likelihood of the request falling in a specific cluster. In the absence of cluster partitions clearly having a new pattern, the demand profiles can be grouped together and in turn can be predicted with Bayesian model.

In some examples, the probabilistic forecast model 214 can perform data analysis to identify trends and patterns in the encrypted historical data 105. In some examples, the probabilistic forecast model 214 can generate demand profiles for various project types, operation types, project durations, enterprise types, and enterprises.

In some examples, the probabilistic forecast model 214 can develop a demand profile for multiple different types of projects. The types of projects can include, for example, construction projects, preventative maintenance projects, corrective maintenance projects, production projects, etc. The probabilistic forecast model 214 can analyze the encrypted historical data 105 to determine a type of project associated with each resource demand. Based on the data analysis, the probabilistic forecast model 214 can generate a demand profile for each type of project. When a resource request is received for a particular project type, the demand forecast model 110 can classify the resource request as being associated with the particular project type, and can select the demand profile for the particular project type.

In some examples, the probabilistic forecast model 214 can develop a demand profile for multiple different types of enterprises. The types of enterprises can include, for example, construction enterprises, retail enterprises, oil and gas enterprises, etc. The probabilistic forecast model 214 can analyze the encrypted historical data 105 to determine a type of enterprise associated with each resource demand. Based on the data analysis, the probabilistic forecast model 214 can generate a demand profile for each type of enterprise. When a resource request is received for a particular type of enterprise, the demand forecast model 110 can classify the resource request as being associated with the particular type of enterprise, and can select the demand profile for the particular type of enterprise.

In some examples, the probabilistic forecast model 214 can develop a demand profile for each enterprise 101. The probabilistic forecast model 214 can analyze the encrypted historical data 105 to determine a particular enterprise associated with each resource demand. Based on the data analysis, the probabilistic forecast model 214 can generate a demand profile for each enterprise. When a resource request is received for a particular enterprise, the demand forecast model 110 can classify the resource request as being associated with the particular enterprise, and can select the demand profile for the particular enterprise.

In some examples, the probabilistic forecast model 214 can identify time-varying trends in the encrypted historical data based on external factors. External factors can include, for example, weather conditions, calendar effects such as days of the week and holidays, seasons of the year, etc. External factors can also include major events such as weather events, geological events, global health events, political events, etc.

In some examples, the probabilistic forecast model 214 can generate a generic demand profile, and update the demand profile over time as additional data is stored in the database 104. For example, the probabilistic forecast model 214 can generate an initial demand profile for a particular type of project. As resource usage reservations are made for the particular type of project, the reservation data is stored in the database 104 as encrypted historical data. The encrypted historical data 105 is used to train and update the probabilistic forecast model 214. Over time, the probabilistic forecast model 214 can become more accurate for predicting demand for the particular type of project.

In some examples, the probabilistic forecast model 214 can generate a generic demand profile, and update the demand profile over time as additional data is stored in the database 104. For example, the probabilistic forecast model 214 can generate an initial demand profile for a particular industry. As resource usage reservations are made for the particular industry, the reservation data is stored in the database 104 as encrypted historical data. The encrypted historical data 105 is used to train and update the probabilistic forecast model 214. Over time, the probabilistic forecast model 214 can become more accurate for predicting demand for the particular industry.

The demand forecast model 110 includes the LSTM model 216. The LSTM model 216 can be trained to predict resource demands using data from the database 104. The LSTM model 216 can be used to predict the future demand using a deep learning based model. The LSTM model 216 can use demand by category, where categories can include, e.g., project names, business units, demand type, volume category, or any combination of these. The LSTM model 216 can be trained with other parameters (e.g. weather, time occurrence) as explanatory variables to predict the demand.

The demand forecast model 110 can generate the demand forecast 120 using the probabilistic forecast model 214, the LSTM model 216, or both. In some examples, the probabilistic forecast model 214 and the LSTM model 216 each generate a candidate demand forecast. One of the candidate demand forecasts is selected from the candidate demand forecasts using a best fit model. The selected candidate demand forecast is then output as the demand forecast 120. The demand forecast 120 can be provided to the application 211. The application 211 receives, as input, the demand forecast 120.

The application 211 can be for example, a resource management and reservation application operating on a computing device, e.g., the computing device 112. The resource management engine 125 receives user input 218 from the application 211. The user input 218 can include, for example, the resource request 108 and/or the demand confirmation 136 of the system 100.

The encryption engine 210 performs homomorphic encryption on the user input 218 and provides encrypted user input 222 to the demand forecast model 110. The demand forecast model 110 processes the encrypted user input 222 using the probabilistic forecast model 214, the LSTM model 216, or both.

The demand forecast model 110 can identify, based on the encrypted user input 122, a type of project or operation associated with the resource demand. The demand forecast model 110 can determine, for encrypted user input 222, the predicted resource demand for the project or operation. The demand forecast model can determine, for encrypted user input 222 specifying a particular type of resource at a particular time and location, a predicted demand for the particular type of resource.

The application 211 includes a user demand forecasting engine 228. The user demand forecasting engine 228 can determine a user demand forecast 230 based on the demand forecast 120. For example, while the demand forecast 120 may include predicted demand for multiple enterprises 101, the user demand forecast 230 can include predicted demand for a particular enterprise associated with a user.

For example, the user 114 associated with Enterprise A may be logged in to the application 211. The user demand forecasting engine 228 can therefore determine the user demand forecast 230 for the user 114 based on the demand forecast 120. In some examples, the user demand forecasting engine 228 can determine the user demand forecast 230 based on profile data of the user 114 and/or based on profile data for enterprise A. For example, the profile data can include past bookings, pre-selected settings, location data, operational classification data, etc.

The application 211 can run a booking engine 212 through which a user can confirm resource demand and reserve resources. A user can input resource requirements through the booking engine 212. For example, the user can input data indicating a cargo manifest, business constraints, and/or technical specifications for requested resources. In some examples, the user input data can include cargo data, project data, booking data and demand data.

In some examples, the user input 218 can be input by a new user and/or a new enterprise that has not previously provided user input to the resource management engine 125. In some examples, the user input 218 can be input for a new project or for a new type of project that has not previously been provided to the resource management engine 125. The demand forecast model 110 can forecast resource demand for the user input 218 from the new enterprise or new user based on data provided with the user input 218. For example, the demand forecast model 110 can predict resource demand based on the type of enterprise, type of project, data indicating external conditions, and other information included in the user input 218.

In this way, as illustrated in FIG. 2, machine learning models can use historical time series data, including seasonality trends, to predict resource demand and create better asset utilization strategies. The resource management engine 125 can use demand forecast models that are pre-trained to incorporate multiple factors including volume, weather, capacity, type of material/personnel movements etc. in its suggested reservations. Using the forecasted demand, supply chain partners can more effectively and efficiently manage resource utilization.

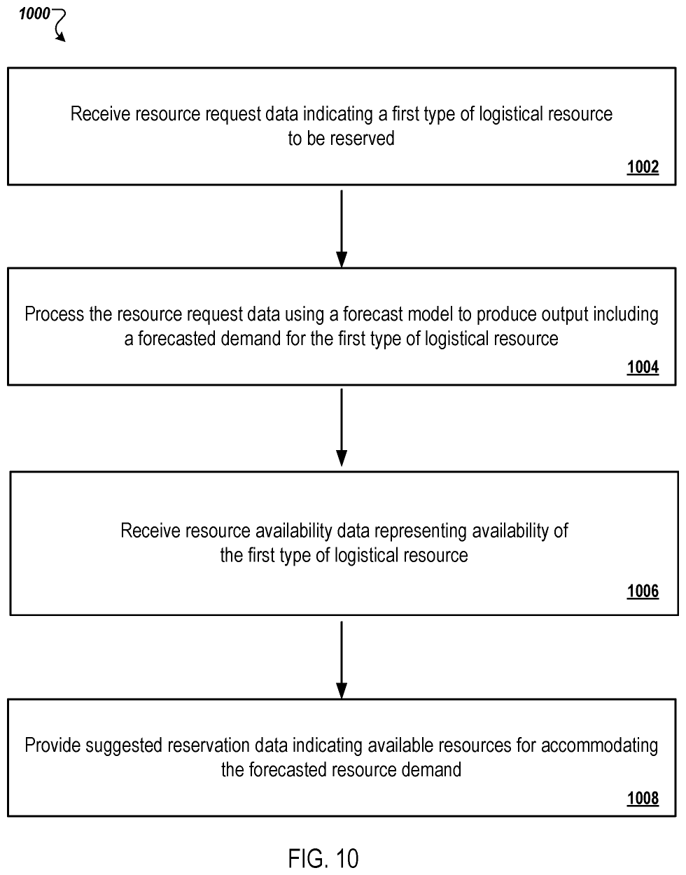

FIG. 10 is a flowchart of an example process 1000 for reserving logistical resources that can be executed in accordance with implementations of the present disclosure. In some implementations, the example process 1000 may be performed using one or more computer-executable programs executed using one or more computing devices.

Resource request data indicating a first type of logistical resource to be reserved for a first enterprise of a plurality of enterprises is received from a first system (1002). For example, and as described herein, the resource management engine 125 can receive the resource request 108 indicating a first type of logistical resource including space for transporting dry goods. The resource request 108 is received from a first system of computing device 112 associated with user 114 of a first enterprise, Enterprise A. The resource request indicates that the space for transporting dry goods is to be reserved for Enterprise A.

The resource data is processed using a forecast model to produce output including a forecasted demand for the first type of logistical resource (1004). For example, and as described herein, the resource request 108 is processed using the demand forecast model 110 to produce the demand forecast 120. The demand forecast 120 can include a forecasted demand for space for transporting dry goods. The demand forecast 120 can also include a predicted starting location, ending location, and time associated with the resource demand. The forecasted demand may include, for example, a volume ten cubic meters.

Resource availability data representing availability of the first type of logistical resource is received from a second system (1006). For example, and as described herein, the resource management engine 125 receives, from one or more resource providers 160, resource availability data 140 representing availability of space for transporting dry goods.

Based on the forecasted demand and on the resource availability data, suggested reservation data indicating available resources for accommodating the forecasted resource demand is provided to the first system (1008). For example, and as described herein, the resource management engine 125 provides, to the computing device 112, suggested reservation data 132 representing available space for transporting dry goods from the predicted starting location to the predicted ending location at the predicted time.

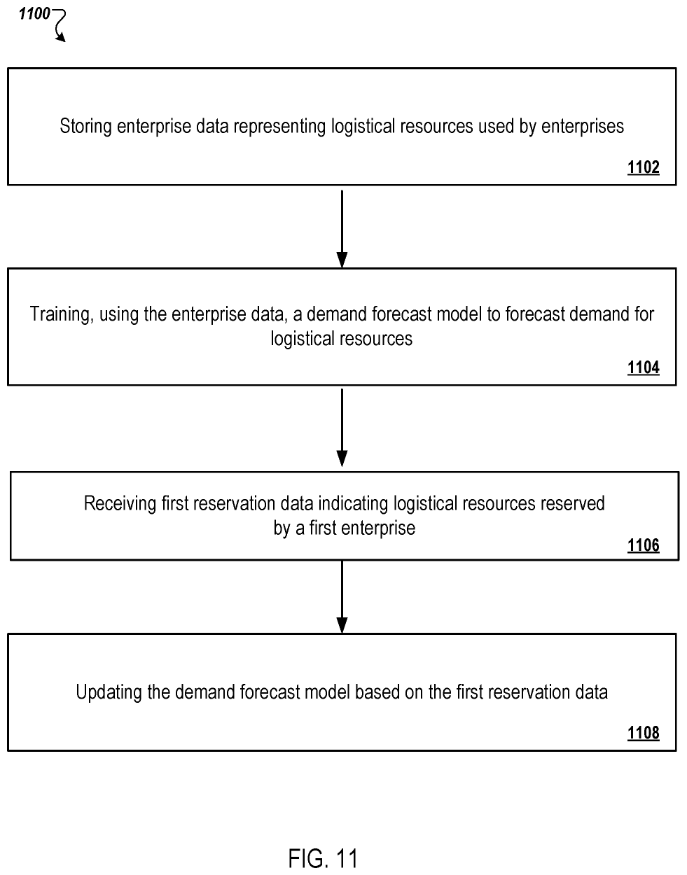

FIG. 11 is a flowchart of an example process 1100 that can be executed in accordance with implementations of the present disclosure. In some implementations, the example process 1100 may be performed using one or more computer-executable programs executed using one or more computing devices.

Enterprise data representing logistical resources used by a plurality of enterprises including first enterprise data for a first enterprise is stored (1102). For example, and as described herein, the resource management engine 125 stores the historical data 102 from the enterprises 101. The enterprises 101 include a first enterprise, Enterprise A.

A demand forecast model is trained, using the enterprise data, to forecast demand for logistical resources while providing security for the first enterprise data (1104). For example, and as described herein, the demand forecast model 110 is trained using the encrypted historical data 105 stored in the database 104. The demand forecast model 110 is trained to forecast demand for logistical resources while providing security for enterprise data from Enterprise A from access by Enterprise B or any third party.

First reservation data indicating logistical resources reserved by the first enterprise is received (1106). For example, and as described herein, the resource management engine 125 receives the demand confirmation 136 from the user 114 of Enterprise A. The demand confirmation 136 indicates logistical resource reserved by Enterprise A. The demand confirmation 136 includes a type of logistical resource, an amount of the logistical resource, a confirmed starting location, a confirmed ending location, and a confirmed time. The resource scheduler 130 of the resource management engine 125 can generate confirmed reservation data 150 by assigning available resources to accommodate the demand of the demand confirmation.

The demand forecast model is updated based on the first reservation data while providing security for the first reservation data (1108). For example, the demand forecast model 110 is updated based on the confirmed reservation data 150. Over time, the demand forecast model 110 is updated based on reservations made by multiple different enterprises and for multiple different project types.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code) that constitutes processor firmware, a protocol stack, a database management system, an operating system, or a combination of one or more of them. A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display), LED (light-emitting diode) monitor, for displaying information to the user and a keyboard and a pointing device (e.g., a mouse or a trackball), by which the user may provide input to the computer. Other kinds of devices may be used to provide for interaction with a user as well; for example, feedback provided to the user may be any appropriate form of sensory feedback (e.g., visual feedback, auditory feedback, or tactile feedback); and input from the user may be received in any appropriate form, including acoustic, speech, or tactile input.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations may be realized in a computing system that includes a back end component (e.g., as a data server), or that includes a middleware component (e.g., an application server), or that includes a front end component (e.g., a client computer having a graphical user interface or a Web browser through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”) (e.g., the Internet).

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method, the computer-implemented method executed by one or more processors and comprising:
receiving, from a first system, resource request data indicating a first type of logistical resource to be reserved by a first enterprise of a plurality of enterprises;
processing the resource request data using a forecast model to produce output including a forecasted demand for the first type of logistical resource;
receiving, from a second system, resource availability data indicating availability of the first type of logistical resource; and
based on the forecasted demand and on the resource availability data, providing, to the first system, suggested reservation data indicating available resources for accommodating the forecasted demand.

2. The method of claim 1, wherein the forecasted demand comprises a forecasted demand of the first enterprise.

3. The method of claim 1, wherein the forecasted demand comprises a forecasted demand of each of the plurality of enterprises.

4. The method of claim 1, comprising:
presenting, by the first system and through a graphical user interface, the suggested reservation data.

5. The method of claim 1, wherein the suggested reservation data includes multiple selectable scheduling options for the available resources, the method comprising:
receiving, from the first system, data indicating a user selection of one or more of the selectable scheduling options; and
in response to receiving the data indicating the user selection, providing, to the second system, a request to reserve the available resources associated with the selected one or more scheduling options.

6. The method of claim 1, comprising:
determining, based on the forecasted demand and on the resource availability data, a predicted cost of the available resources,
wherein the suggested reservation data includes data indicating the predicted cost of the available resources.

7. The method of claim 1, wherein the forecast model comprises a convolutional neural network model.

8. The method of claim 1, wherein the first type of logistical resource comprises at least one of a resource for transporting material or a resource for transporting personnel.

9. A method for training a demand forecast model comprising:
storing, in a database, enterprise data indicating logistical resources used by a plurality of enterprises, including first enterprise data for a first enterprise;
training, using the enterprise data, the demand forecast model to forecast demand for logistical resources while providing security for the first enterprise data from access by the plurality of enterprises and any third party;
receiving first reservation data indicating logistical resources reserved by the first enterprise; and
updating the demand forecast model based on the first reservation data, while providing security for the first reservation data from access by the plurality of enterprises and any third party.

10. The method of claim 9, comprising training, using the enterprise data, the demand forecast model to forecast demand for logistical resources for each of the plurality of enterprises.

11. The method of claim 9, comprising:
receiving reservation data indicating logistical resources reserved by one or more of the plurality of enterprises; and
updating the demand forecast model based on the reservation data.

12. The method of claim 9, comprising:
receiving, from the plurality of enterprises, unencrypted enterprise data;
encrypting the enterprise data using homomorphic encryption; and
storing the encrypted enterprise data in the database.

13. The method of claim 9, wherein the demand forecast model comprises a convolutional neural network model.

14. A non-transitory computer-readable storage medium coupled to one or more processors and having instructions stored thereon which, when executed by the one or more processors, cause the one or more processors to perform operations comprising:
receiving, from a first system, resource request data indicating a first type of logistical resource to be reserved by a first enterprise of a plurality of enterprises;
processing the resource request data using a forecast model to produce output including a forecasted demand for the first type of logistical resource;
receiving, from a second system, resource availability data indicating availability of the first type of logistical resource; and
based on the forecasted demand and on the resource availability data, providing, to the first system, suggested reservation data indicating available resources for accommodating the forecasted demand.

15. The non-transitory computer-readable storage medium of claim 14, wherein the forecasted demand comprises a forecasted demand of the first enterprise.

16. The non-transitory computer-readable storage medium of claim 14, wherein the forecasted demand comprises a forecasted demand of each of the plurality of enterprises.

17. The non-transitory computer-readable storage medium of claim 14, the operations comprising:
presenting, by the first system and through a graphical user interface, the suggested reservation data.

18. The non-transitory computer-readable storage medium of claim 14, wherein the suggested reservation data includes multiple selectable scheduling options for the available resources, the operations comprising:
receiving, from the first system, data indicating a user selection of one or more of the selectable scheduling options; and
in response to receiving the data indicating the user selection, providing, to the second system, a request to reserve the available resources associated with the selected one or more scheduling options.

19. The non-transitory computer-readable storage medium of claim 14, the operations comprising:
determining, based on the forecasted demand and on the resource availability data, a predicted cost of the available resources,
wherein the suggested reservation data includes data indicating the predicted cost of the available resources.

20. The non-transitory computer-readable storage medium of claim 14, wherein the forecast model comprises a convolutional neural network model.
